(19) United States
(12) Patent Application Publication
(10) Pub. No.: US 2006/0027083 A1
(43) Pub. Date: Feb. 9, 2006

(54) Explosive bolt

(75) Inventors: Yeung-Jo Lee, Daejeon (KR); Chang-Sun Choi, Daejeon (KR); Dong-Jin Kim, Seoul (KR)

Correspondence Address: Leopold Presser;Scully, Scott, Murphy & Presser, 400 Garden City Plaza, Garden City, NY, 11530, US

(73) Assignee: Agency for Defense Development, Daejeon (KR)

(21) Appl. No.: 11/023,756

(22) Filed: Dec. 28, 2004

(30) Foreign Application Priority Data
Jul. 21, 2004 (KR) 56916/2004

(51) Int. Cl. B64D 1/04

(52) U.S. Cl. 89/1.14

(57) ABSTRACT

An explosive bolt includes: a bolt body forming a receiving space therein; a pressure transmitting means received in the receiving space of the bolt body; a pressure generating means connected to the pressure transmitting means and generating pressure; and a cut portion formed at the bolt body and cut upon receiving pressure generated from the pressure generating means through the pressure transmitting means. Accordingly, the amount of gunpowder used is minimized, and a position of a cut portion can be freely designed and fixed, thereby not only minimizing explosion impact and noise but also improving productivity and reliability.

### BACKGROUND OF THE INVENTION

1. Field of the Invention

The present invention relates to an explosive bolt, and particularly, to an explosive bolt transmitting pressure generated in explosion to a cut portion and cutting the cut portion.

2. Description of the Background Art

A means for cutting coupled two parts is being commonly used in fields related to multi-stage rockets, rocket boosters, space missiles and commercial vehicles. Currently, an explosive bolt is a representative cutting means for immediately separating coupled two parts into two parts or more, and this is disclosed in Korean Patent Application Publication Nos. 1994-04227, 2000-09634 and the like.

FIGS. 1 and 2 shows conventional explosive bolts.

As shown in FIG. 1, an ignition device 2 installed inside a bolt body 1 coupling two parts is operated by receiving an electric signal through a lead line 2, and separation gunpowder 3 filled in the bolt body 1 is exploded by such operation of the ignition device 2. Then, the bolt body 1 is cut into two parts by an explosive force of the separation gunpowder 3, thereby causing separation of two parts.

Another conventional art shown in FIG. 2 includes a bolt body 11 having a cylindrical explosive means mounting portion 12 therein; an ignition means 13 detachably coupled to the bolt body 11; and separation gunpowder 14, powder filled in a lower portion of the ignition means 13. As the above-mentioned invention, the bolt body is separated by explosion of the separation gunpowder 14 due to the operation of the detonator 13.

However, such a conventional explosion bolt has following problems.

First, noise and impact generated in explosion may disturb electronic devices or sensitive sensors near the explosion, generate cracks on a liquid carrying pipe or cause mal-functioning of the device.

Secondly, because cutting is made at a random position, it is impossible to anticipate a cut position and the cut position cannot be freely controlled. Because of such difficulties, an accident may occur due to undesired explosion, and a cut surface of the bolt body cannot be freely modified and designed.

Thirdly, the ignition means is not easily assembled and is not suitable to employ in a bolt which is small or has a complex shape. Accordingly, a manufacturing process becomes complex, and its manufacturing cost is increased.

Such problems more severely occur as the amount of gunpowder used is increased. Namely, if the amount of gunpowder being used is increased, noise and impact also increase, and it becomes more difficult to anticipate a cut position.

### SUMMARY OF THE INVENTION

Therefore, an object of the present invention is to provide an explosive bolt capable of minimizing explosion impact and noise and improving productivity and reliability by minimizing the amount of gunpowder used and by freely designing and fixing a position of a cut portion.

To achieve these and other advantages and in accordance with the purpose of the present invention, as embodied and broadly described herein, there is provided an explosive bolt comprising: a bolt body forming a receiving space therein; a pressure transmitting means received in the receiving space of the bolt body; a pressure generating means connected to the pressure transmitting means and generating pressure; and a cut portion formed at the bolt body and cut upon receiving pressure generated from the pressure generating means through the pressure transmitting means.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a sectional view showing a conventional explosive bolt;

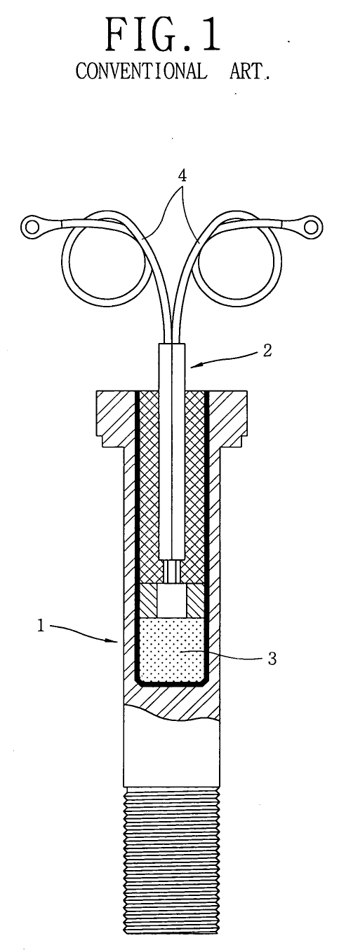

FIG. 2 is a sectional view showing another conventional explosive bolt;

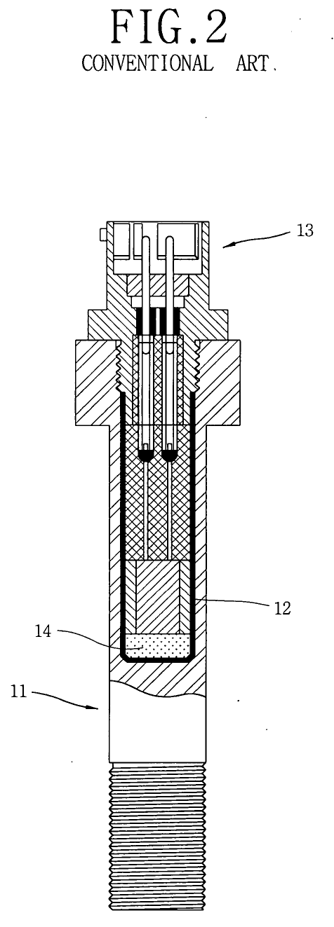

FIG. 3 is a sectional view showing a first embodiment of an explosive bolt in accordance with the present invention;

FIG. 4 is a cut-out perspective view showing a pressure generating means included in the first embodiment of the present invention;

FIG. 5 is a photograph showing an explosive bolt after cutting in accordance with the first embodiment of the present invention; and

FIG. 6 is a sectional view showing a second embodiment of an explosion bolt in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

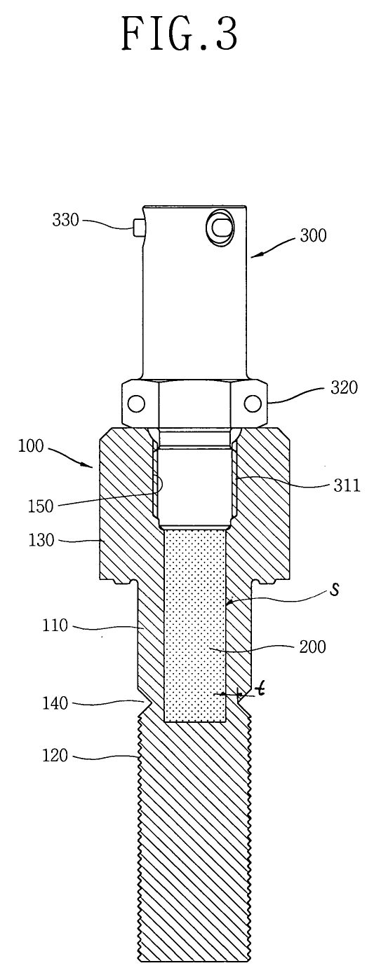

FIG. 3 is a sectional view showing a first embodiment of an explosion bolt in accordance with the present invention.

As shown, the explosion bolt in accordance with the present invention includes a bolt body 100 forming a receiving space (S) therein; a pressure transmitting means 200, an uncompressible material received in the receiving space (S) of the bolt body 100; a pressure generating means 300 coupled to the bolt body 100, generating pressure and transmitting the pressure to the pressure transmitting means 200; and a cut portion 140 formed at the bolt body 100 and cut upon receiving the pressure.

The bolt body 100 includes a body portion 110; a screw portion 12 formed at one end of the body portion 110; and a head portion 130 formed at the other of the body portion 110. Preferably, SUS304 or SUS630 is used for the bolt body 100, but it is not limited thereby.

The cut portion 140 is formed at an outer circumferential surface of a boundary portion between the body portion 110 and the screw portion 120. A notch is formed at the cut portion 14 so that a cut position can be predetermined.

The receiving space (S) is formed from a boundary portion between the body portion 110 and the screw portion 120 to an end of the head portion 130. The receiving space (S) is opened at the end of the head portion 130, and a female screw portion 150 to be coupled to the pressure generating means 130 is formed at the opened portion.

Preferably, the pressure transmitting means 200 is a flexible material such as water, oil or a gel type material. Preferably, anti corrosion oil is used as the pressure transmitting means 200.

The pressure generating means 300 includes a case 310 and parts mounted in the case 310 and needed for ignition.

The case 310 includes a male screw portion 311 screw-coupled to the female screw portion 150 of the bolt body 100; and a head portion 130 at which a rotating tool such as spanner, wrench or the like gets caught when the pressure generating means 300 is screw-coupled to the bolt body 100.

When coupled to the bolt body 100, most parts except the male screw portion 311 are assembled in an exposed state. An electric signal input terminal 330 is provided at an outer circumferential surface of the exposed portion of the case 310.

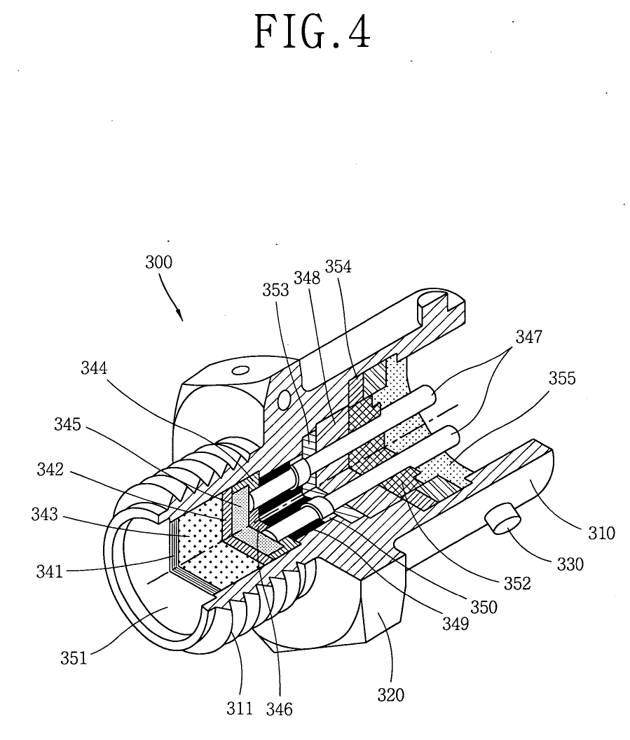

FIG. 4 is a cut-out perspective view showing one example of a pressure generating means used in the present invention.

As shown, the pressure generating means 300 includes main gunpowder 343 surrounded by a mica separation film 341 and a borron nitride separation film 342, ignition gunpowder 345 surrounded by the boron nitride separation film 342 and a borron nitride header 344; an ignition line 346 installed at an upper surface of the ignition gunpowder 345; a pair of contact pins 347 having lower ends connected to the ignition line 346 and upper ends exposed at an upper end of the case 310; and an RF filter (Radio Frequency filter) 348 installed at a middle portion of the contact pin 347.

Glass beads 349 for maintaining an insulation state hermetically covers lower end portions of the pair of contact pins 347, and a spark preventing gap 350 for preventing a contact between an inner circumferential surface of the case 310 and an outer circumferential surface of the contact pin 347 is formed right above the glass beads 349.

Non-explained reference number 351 in the drawing is a protection film installed at a lower end of the case, 352 is an insulation rubber installed at an upper end of the case, 353 and 354 are charging materials for spacer, and 355 is a protection film.

Preferably, the main gunpowder 343 and the ignition gunpowder 345 are made of ZPP 65 mg/BKNO₃ 300 mg. A maximum forming pressure obtained by an experiment, of the pressure generating means 300, is 1500 psi±300 psi.

Preferably, an RFI (Radio Frequency Initiator) is used as the pressure generating means 300.

Operational effect of the present invention will now be described.

When an electric signal is applied to the pressure generating means 300 through an electric signal input terminal 330 of the pressure generating means 300, the pressure generating means 300 is operated by the electric signal to thereby generate pressure. Namely, when an electric signal is applied through the electric signal input terminal 330, the signal is transmitted to the ignition line 346 through the contact pin 347, the ignition gunpowder 345 is detonated by heat generated by the ignition line 346, and then the main gunpowder 343 is exploded, thereby generating pressure downward toward a lower side of the case 310.

The pressure generated from the pressure generating means 300 is transmitted to the pressure transmitting means 200 that is charged in a receiving space (S) of the bolt body 100.

At this time, because the pressure transmitting means 200 is a flexible material having compressibility which is very low or close to zero, the pressure generated by the pressure generating means 300 is transmitted to the bolt body 100 through the pressure transmitting means 200 as it is, and the pressure is concentrated on the cut portion 140 of the bolt body 100, where the notch is formed. Accordingly, the bolt body 100 is cut exactly at the portion where the notch is formed, namely, at a boundary portion between the body portion and the screw portion.

At this time, the pressure generated from the pressure generating means 300 is transmitted through the pressure transmitting means 200 in a longitudinal direction of the bolt body 100. Namely, the pressure is partially generated in a radial direction, but it is just a very small amount. After all, the pressure is concentratively applied to the cut portion 140 having the notch located at a boundary portion between the body portion and the screw portion. Because the pressure works as an extension force in a longitudinal direction of the bolt body 100 to a section between an inner circumferential surface of the receiving space (S) and a valley portion of the notch, cutting is made at a cut section.

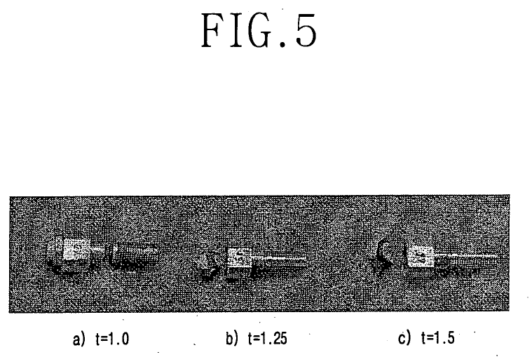

FIG. 5 shows an explosive bolt after cutting in accordance with an embodiment of the present invention. In FIG. 5, a) shows a case that a thickness between the inner circumferential surface of the receiving space and the valley portion of the notch is 1 mm, b) shows a case of 1.24 mm and C) shows a case of 1.5 mm. As shown, it can be seen that if ‘t’ is 1 mm or smaller, the explosive bolt is cut into two parts at a prearranged cut sectional portion without any broken pieces, that is, at a cut portion where the notch is formed. Also, it can be seen that if ‘t’ is greater than 1 mm, the cutting is not made exactly at the prearranged cut portion.

In the experiment, the time consumed to cut the explosive bolt after an electric signal is inputted to the pressure generating means was 5 msec.

In addition, it can be seen by an experiment that because separation gunpowder for the conventional explosive bolt was not used in the explosive bolt according to the present embodiment, the amount of gunpowder used is reduced, thereby reducing explosion impact by ⅕ or less. The experiment was carried out under conditions that pressure of the used pressure generating means was 1500 psi, a material of a bolt body was SUS304, and a thickness between an inner circumferential surface of the receiving space and a valley portion of the notch was 1 mm. ‘t’ may be varied depending on a kind of material of the bolt body, a heat treatment and a shape of the notch.

In addition, when a screw standard was 1/2-20UNF-5A, the explosive bolt was cut exactly at a desired cut portion within 3 msec in all experiments made at a room temperature, a low temperature and a high temperature.

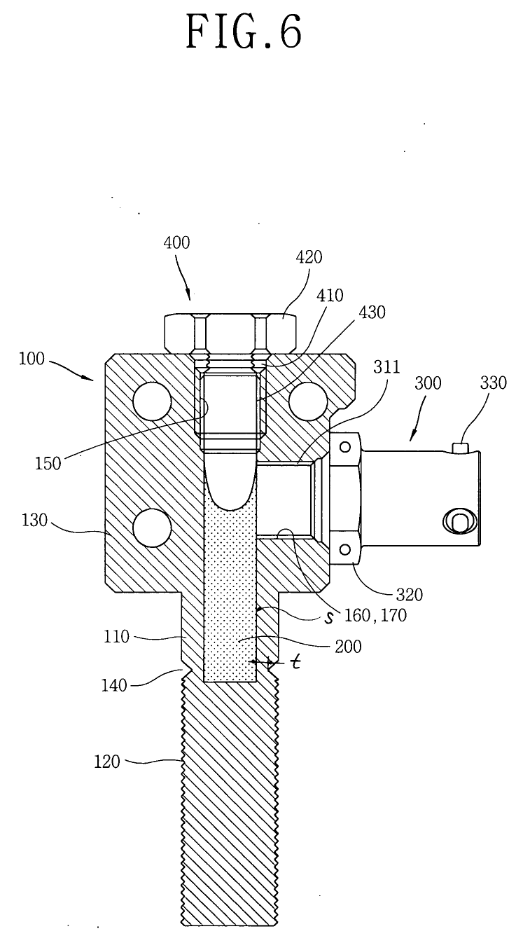

FIG. 6 shows a second embodiment of the explosive bolt in accordance with the present invention. In the second embodiment, a coupling hole 160 to which a pressure generating means 300 is coupled is formed perpendicular to the receiving space (S) at a head portion 130 of the bolt body 100. A female screw portion 170 is formed at an inner circumferential surface of the coupling opening 160, and a male screw portion 311 of the pressure generating means 30 is screw-coupled to the female screw portion 170, so that the pressure generating means 300 is coupled to the bolt body 100. In the second embodiment, a closing means 400 for closing an opened portion of the receiving space (S) is further included. Because other structures are the same as those of the first embodiment, the same reference numbers are given to the same parts, and detailed descriptions thereon will be omitted.

The closing means 400 includes a body portion 410, a head portion 420 formed at one end portion of the body portion 410, at which a rotating tool such as spanner, 9+wrench or the like gets caught; and a screw portion 430 formed at the other end portion of the body portion 410 and screw-coupled to a female screw portion 150 formed at the opened portion of the receiving space (S).

In the explosive bolt in accordance with the second embodiment having a such a structure, although a position where the pressure generating means is coupled to the bolt body is different from that of the above-mentioned first embodiment, its substantial operation is the same as that of the first embodiment.

The explosive bolt described above has following advantages.

First, in an explosive bolt in accordance with the present invention, cutting of the bolt is made by transmitting only pressure generated from the pressure generating means to a bolt body through a pressure transmitting means received in the bolt body without using separation gunpowder and connection gunpowder. Therefore, explosion impact is remarkably reduced, and the amount of fatal impact affecting electronic equipment, kinds of sensitive sensors or the like near the explosion is greatly reduced too, thereby preventing malfunctioning or a break-down of the electronic equipment and the like.

In addition, because separation gunpowder or connection gunpowder is not used, prevention against an accident due to undesired explosion, and management thereof can be easily made.

Also, because pressure generated from a pressure generating means can be transmitted to a desired position through a pressure transmitting means that is charged in a bolt body, a section to be separated, of the bolt body can be freely modified and designed, and a shape and a size can be variously changed, thereby facilitating separation, or operation and construction of an discharge system.

In addition, the separation can be made by charging a pressure transmitting means inside the bolt body without using separation gunpowder or connection gunpowder, thereby facilitating a manufacturing process and reducing a manufacturing cost.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An explosive bolt comprising:
a bolt body forming a receiving space therein;
a pressure transmitting means received in the receiving space of the bolt body;
a pressure generating means connected to the pressure transmitting means and generating pressure; and
a cut portion formed at the bolt body and cut upon receiving pressure generated from the pressure generating means through the pressure transmitting means.

2. The explosive bolt of claim 1, wherein the bolt body comprises:
a body portion;
a screw portion formed at one end of the body portion; and
a head portion formed at the other end of the body portion.

3. The explosive bolt of claim 2, wherein the receiving space of the bolt body is formed from a boundary portion between the body portion and the screw portion to an end of the head portion, and is opened at the end of the head portion.

4. The explosive bolt of claim 3, wherein a coupling hole is formed perpendicular to the receiving space to be coupled to the pressure generating means.

5. The explosive bolt of claim 4, wherein the explosive bolt comprises a closing means for closing the receiving space by being coupled to the opened portion of the receiving space.

6. The explosive bolt of claim 1, wherein the pressure transmitting means is a liquid material having small compressibility and fluidity.

7. The explosive bolt of claim 6, wherein the pressure transmitting means is water.

8. The explosive bolt of claim 6, wherein the pressure transmitting means is oil.

9. The explosive bolt of claim 6, wherein the pressure transmitting means is a gel type material.

10. The explosive bolt of claim 6, wherein the pressure transmitting means is anti corrosion oil.

11. The explosive bolt of claim 2, wherein the cut portion is formed at an outer circumferential surface of a boundary portion between the body portion and the screw portion.

12. The explosive bolt of claim 11, wherein the cut portion has a groove in a circumferential direction.

13. The explosive bolt of claim 1, wherein the cut portion has a notch so that a cut position can be predetermined.

14. The explosive bolt of claim 13, wherein the notch is formed in plurality.

15. The explosive bolt of claim 13, wherein a thickness between an inner circumferential surface of the receiving space and a valley portion is 1 mm or smaller.
